(19) United States
(12) Patent Application Publication
(10) Pub. No.: US 2012/0085639 A1
(43) Pub. Date: Apr. 12, 2012

(54) CATHODE BOTTOM, METHOD FOR PRODUCING A CATHODE BOTTOM, AND USE OF THE SAME IN AN ELECTROLYTIC CELL FOR PRODUCING ALUMINUM

(75) Inventors: Oswin Oettinger, Meitingen (DE); Frank Hiltmann, Kriftel (DE)

(73) Assignee: SGL CARBON SE, WIESBADEN (DE)

(21) Appl. No.: 13/377,245

(22) PCT Filed: Jun. 1, 2010
(86) PCT No.: PCT/EP10/57667

§ 371 Date: Dec. 9, 2011

(30) Foreign Application Priority Data
Jun. 9, 2009 (DE) 10 2009 024 881.1

(51) Int. Cl. C25C 7/02; B32B 38/18; C09J 7/00; B32B 37/12

(52) U.S. Cl. 204/242; 156/60; 156/246; 156/313; 204/290.15

(57) ABSTRACT

A cathode bottom for an electrolytic cell for producing aluminum, includes a material which can be disposed on at least one cathode block. The material includes a pre-compressed plate based on expanded graphite. A method for producing a cathode bottom includes providing at least one cathode block and placing a material, including at least one pre-compressed plate based on expanded graphite, on at least one surface of the at least one cathode block. The cathode bottom is used in an electrolytic cell for producing aluminum.

This invention relates to a cathode bottom, a method for producing the same, and the use thereof in an electrolytic cell for producing aluminum.

In general, aluminum is produced by igneous electrolysis in so-called electrolytic cells. An electrolytic cell generally comprises a tray made of sheet iron or steel, the bottom of which is lined with thermal insulation. Inside this tray, up to 24 cathode blocks of carbon or graphite, which are connected to the negative pole of a power source, make up the bottom of another tray, the wall of which consists of side wall blocks made of carbon, graphite, or silicon carbide. Between two cathode blocks, respectively one gap is formed. The arrangement of a cathode block and a possibly filled gap is generally called a cathode bottom. Conventionally, the gaps between the cathode blocks are filled with ramming mass made of carbon and/or graphite with tar. This is used for sealing against molten components and compensating for mechanical stress during commissioning. The cathode blocks and the ramming mass are used as a cathode bottom. Short carbon blocks, which are suspended from a supporting frame connected to the positive pole of the power source, are used as an anode.

Inside such an electrolytic cell, a molten mix of aluminum oxide (Al₂O₃) and cryolite (Na₃AlF₆), preferably about 15 to 20% of aluminum oxide and about 85 to 80% of cryolite, is subjected to igneous electrolysis at a temperature of about 960° C. Herein, the dissolved aluminum oxide reacts with the solid carbon block anode and form liquid aluminum and gaseous carbon dioxide. The molten compound covers the side walls of the electrolytic cell with a protective crust, while aluminum, due to the greater density thereof in comparison with the density of the molten mass, collects at the bottom of the electrolytic cell below the molten mass so as to be protected from back oxidation by atmospheric oxygen. The aluminum thus produced is removed from the electrolytic cell and refined.

During electrolysis, the anode is consumed, while the cathode bottom exhibits chemically inert behavior. Consequently, the anode is a wear part, which will be replaced in the course of the operating time, while the cathode bottom is designed for long-term and permanent operation. Nevertheless, current cathode bottoms are subject to wear. The aluminum layer moving across the cathode bottom will produce mechanical abrasion of the cathode surface. Moreover, due to the formation of aluminum carbide and sodium dispersion (electro-) chemical corrosion of the cathode bottom will occur. Also, particle adhesion to the cathode surface will lead to structural weakening thereof. As in general, between 100 and 300 electrolytic cells are connected in series so as to obtain an economical plant for the production of aluminum, and such a plant is to be operated in general for at least 4 to 10 years, failure and replacement of a cathode block in an electrolytic cell of such a plant may be expensive and require sophisticated repairs, which will largely decrease the profitability of the plant.

One shortcoming of the electrolytic cell illustrated above, which has ramming mass made of carbon and/or graphite with tar, is that for technical reasons, such as for instance mechanical stability, or the ramming procedure, it is not possible to make thin layers of the coarse-grained ramming mass so that gaps are apparent, which on the one hand will reduce the cathode surface, and into which aluminum and particles may disperse on the other hand, thereby increasing wear on the cathode bottom.

The mostly used anthracite ramming mass is less electrically and thermally conductive than in particular graphitized cathode blocks. Thus, effective cathode surface is lost, and the greater combined resistance will lead to higher energy consumption, thereby reducing profitability of the process. Moreover, wear of the cathode bottom is increased due to the higher specific flow rate.

One alternative consists in gluing the blocks together into one monolithic cathode bottom, but this is a problem due to the thermo-mechanical stress thereof, and therefore is hardly applied.

Consequently, this invention is based on the object to provide a means to increase the cathode surface and which is suitable for forming a cathode bottom having a large cathode surface. Moreover, the present invention is based on the object of providing a simple method for producing a cathode bottom having a large cathode surface.

This object is solved by a cathode bottom having the features of claim 1, and by a method having the features of claim 8.

According to the invention, provision is made for the cathode bottom to include a material, which can be arranged on at least one cathode block, and which is characterized in that the material comprises a pre-compressed plate based on expanded graphite. Hereafter, the pre-compressed plate based on expanded graphite will also be designated as a pre-compressed graphite plate. For the purpose of this invention, both terms are interchangeable and designate a pre-compressed plate made of expanded graphite, which may also include further additives. Therefore, the means to increase the cathode surface is the material comprising a pre-compressed graphite plate. The material can be non-positively connected to the cathode block. The pre-compressed graphite plate used according to the invention can be implemented in the areas of an electrolytic cell, where conventionally ramming mass is used, i.e. in particular in gaps, which have formed between cathode blocks, but also in spaces located between the side walls of the electrolytic cell and the cathode blocks. The pre-compressed graphite plate is used in particular as a sealing means between the cathode blocks of a cathode bottom.

A cathode bottom having a pre-compressed graphite plate has a large effective cathode surface due to the possibility of stringing together by means of non-positive connection a plurality of cathode blocks, the feasible dimensions of which are limited by what is economically and technically producible.

One advantageous effect is the physiological harmlessness of the pre-compressed graphite plate in comparison with the conventional carbon mass containing tar pitch and polycyclic aromatic hydrocarbons, which are health-threatening. Moreover, regarding the conventional tar pitch-containing carbon mass, the pre-compressed graphite plate has higher electrical and thermal conductivity and thus also increases the cathode surface.

Expanded graphite has the following advantageous properties: It is non-hazardous to health, environmentally compatible, soft, compressible, light-weight, non-ageing, chemically and thermally resistant, technically gas and liquid-tight, non-combustible, and easily workable. Moreover, it does not form an alloy with liquid aluminum. Therefore, it is suitable as a material for a cathode bottom for an electrolytic cell for the production of aluminum.

Expanded graphite can be obtained by chemical and thermal treatment of graphite, such as for instance natural graphite. During the production process, the graphite may undergo volumetric sizing by a factor between 200 and 400, with thermal and electrical conductivity being preserved.

E.g., graphite will be treated with a dispersive solution, such as for instance sulphuric acid, so as to form a graphite dispersion compound (a graphite salt). Next, thermal decomposition at about 1000° C. is performed, wherein the dispersed agents will be removed from the expanded graphite. The expanded graphite thus obtained can be further processed e.g. by compounding, pressing, impregnating, rolling, and calendaring. E.g., the expanded graphite may be further condensed into graphite films or plates. In this invention, preferably a pre-compressed plate based on expanded graphite is used, which is produced as mentioned above. However, the pre-compressed graphite plate may also be further impregnated with resins. Expanded graphites are commercially available e.g. from SGL Carbon SE.

For the purpose of this invention, a pre-compressed plate based on expanded graphite comprises expanded graphite, which has been condensed, but which may be further condensed. I.e., a pre-compressed graphite plate is meant to designate plate-shaped expanded graphite, which is partially compressed, and which therefore both has been pressed and can be pressed.

Preferably, the pre-compressed graphite plate is made as at least one plate. For the purpose of this invention, the pre-compressed plate, which includes more than one plate, has stacked plates. The stacked plates can be glued together by means of an adhesive, such as for instance a phenolic resin.

Preferably, the material which can be arranged at the cathode block consists of a pre-compressed graphite plate based on expanded graphite. In addition, inorganic or organic additives can be introduced, e.g. titanium diboride and zirconium diboride.

In a preferred embodiment, the pre-compressed graphite plate is made as a film. Films are thin, flexible, and easy to adapt to the shape of the surroundings thereof. E.g. the film can be adapted easily to the dimensions of a gap between cathode blocks and the surface condition of cathode blocks. Moreover, a film has a sheet-shaped structure. Therefore, a film also has the advantage that it can be stacked without creating cavities.

In a preferred embodiment, the cathode bottom comprises at least one cathode block, which is arranged at a predetermined distance from another cathode block so that at least one gap is made therebetween. The material including the pre-compressed plate based on expanded graphite will fill the gap and non-positively connect the cathode blocks. Using a pre-compressed graphite plate instead of the conventionally used carbon ramming mass allows for the width of the gap between cathode blocks to be reduced, and thus for the effective cathode surface to be increased. The material is used as a filler between the two cathode blocks, which cannot only seal the gap between both cathode blocks, but also, due to the compressible nature thereof, compensate expansion of the cathode blocks which will occur during electrolysis. The material and the cathode blocks are non-positively connected and are preferably flush. The material and the cathode block can be glued together, e.g. by means of a phenolic resin.

The cathode blocks preferably have a larger length dimension than width dimension, while the width and height dimensions are approximately the same. In general, cathode blocks have a length of up to 3800 mm, a width of up to 700 mm, and a height of up to 500 mm. Preferably, the at least two cathode blocks are arranged so that the length dimensions thereof are parallel. The predetermined clearance between two cathode blocks is about 1/10 to 1/100 of the width dimension of the cathode block. Reducing the clearance between cathode blocks is possible by using the material according to this invention. Thus, for instance when 650 mm-wide cathode blocks are implemented, clearance between the cathode blocks must be at least 40 mm if conventional ramming mass is used as a filler therebetween, while it may be reduced to 10 mm if the pre-compressed graphite plate is used. In the AP30 technology, for instance with 650 mm-wide cathode blocks and 40 mm-wide gaps, a reduction to 10 mm will increase the effective cathode block surface by about 5%.

Preferably, the at least one cathode block comprises at least one means for connecting to a power source. E.g., the cathode block has at least one recess to receive a conductor rail, which can be connected to a power source. If at least two cathode blocks are aligned so that the length dimensions thereof are parallel, the recess is preferably aligned in the longitudinal direction of the cathode block, i.e. the recess will extend in parallel to the gap formed between two cathode blocks. Of course, the cathode bottom may further have a compound element between cathode block and conductor rail, such as for instance contact mass and the like.

The at least one cathode block is configured to be electrically and thermally conductive, resistant to high temperatures, chemically stable to electrolytic bath components, and incapable of forming an alloy with aluminum. The cathode block is preferably made of graphite, half-graphitic, graphitized, half-graphitized, and/or amorphous carbon. More preferably, the cathode block comprises graphite or graphitized carbon, because they best satisfy the requirements in thermal and electrical conductivity, and chemical stability for forming a cathode bottom in an electrolytic cell for producing aluminum.

In the preceding preferred embodiment including the at least two cathode blocks with the highly conductive cathode block areas, and the Material comprising the pre-compressed plate based on expanded graphite, the cathode bottom comprises areas which will in general have lower conductivity than the cathode blocks, but which are capable of sealing the gaps formed between the cathode blocks so that none of the bath components may penetrate into areas of the cathode bottom during electrolysis. Consequently, the two components, i.e. the cathode blocks and the pre-compressed graphite plate, will fulfill different functions of the cathode bottom. Due to the multifunctional construction thereof, this cathode bottom can thus be dimensioned for large-scale implementation. Due to the arrangement of a plurality of cathode blocks, a large conductive cathode surface is obtained, and due to efficient sealing of the gaps between the cathode blocks with the pre-compressed graphite plate, wear and tear of the cathode surfaces between the cathode blocks are prevented.

In another preferred embodiment, one surface of the at least one cathode block, located opposite a surface of another cathode block, is textured. A textured surface can be created for instance by roughening of the surface. Alternatively, one surface of the at least one cathode block, located opposite a surface of another cathode block, has at least one groove, which may extend for instance in a staggered form. The grooving or texturing of the surface of the cathode block will improve fitting of the pre-compressed graphite plate into the gap. The pre-compressed graphite plate is arranged at the textured or grooved surface, and possibly glued therewith and will thereby fill the grooved or textured surface of the cathode block. Due to the grooved or textured surface being filled by the pre-compressed graphite plate, the latter will positively fit into the surface of the cathode block. In this embodiment, the connection between the pre-compressed graphite plate and the cathode block is both non-positive and positive. The number and the dimensions of the grooves in the surface of the cathode block will depend on dimensions of the cathode block. Also, the degree of roughening of the surface of the cathode block will depend on the dimensions thereof.

In another preferred embodiment, the material is arranged on two opposite surfaces of a cathode block, adjacent to the gap-forming surface, as well as at and inside the gap, so that the material is flush. For the purpose of this invention, the material being flush means that the material is arranged on the cathode blocks so that the cathode bottom will have respectively uniform dimensions along the length, height, and width thereof. For a cathode bottom inside an electrolytic cell, there is an interval between the side walls of the electrolytic cell and the cathode blocks. In this case, the material is arranged so as to fill the gaps between the cathode blocks as well as the areas between cathode blocks and side walls, and the areas between the gaps filled with material and the side walls. Thus, the cathode bottom forms the entire bottom of the electrolytic cell, i.e. it extends up to all side walls of the electrolytic cell, having areas of higher thermal and electrical conductivity as cathode blocks, and areas with lower thermal and electrical conductivity as the material of expanded graphite. In this embodiment, preferably all of the surfaces of a cathode block, which are in touch with the material including the pre-compressed plate based on expanded graphite, are textured and/or grooved so that the material is connected to said surfaces not only non-positively but also positively.

A method for producing the cathode bottoms according to the invention comprises the following procedural steps:

providing at least one cathode block, and

arranging a material on at least one surface of the at least one cathode block, wherein the material comprises at least one pre-compressed plate based on expanded graphite.

The production of a cathode bottom having a pre-compressed plate based on expanded graphite allows for a highly effective cathode surface to be obtained due to the possibility of stringing together a plurality of cathode blocks. The production of the cathode block is performed so that the material is non-positively connected to the at least one cathode block by the arrangement thereon, an adhesive being be employed in addition, if required.

In a preferred embodiment, the method according to the invention further comprises the following procedural step:

arranging at least one further cathode block at a predetermined distance from the at least one cathode block so that the material will fill a gap, which is formed by the arrangement of the further cathode block at the predetermined distance from the at least one cathode block.

Arranging the further cathode block on the cathode block allows for a non-positive connection to be obtained between the cathode blocks by means of the pre-compressed graphite plate. The arrangement of the further cathode block is done by hydraulic or mechanical pressing, possibly using glue. The method according to the invention allows for the width of the gap between the cathode blocks to be reduced in comparison with conventional gap width and thereby for the effective cathode surface to be increased.

The pre-compressed graphite plate filling the gap is compressible, but partially reversible, so that it may compensate expansion of the cathode blocks. It should be noted here again that for the purpose of this invention, a pre-compressed graphite plate is understood to be partially compressed expanded graphite, which has been pressed and may be further pressed. When the further cathode block has been arranged, a pre-compressed graphite plate is obtained inside the gap, representing a material of low elasticity sealing the gap without forming cavities. The step of arranging at least one further cathode block can be performed before or after the material is arranged on the at least one cathode block.

In a preferred embodiment, the procedural step of arranging the material on at least one surface of the at least one cathode block comprises fastening to the surface of at least one cathode block by means of an adhesive. E.g., a phenolic resin may be used as an adhesive.

Before or after being provided, the cathode blocks may be fitted with means for connecting to a power source. E.g., before or after being provided, a cathode block may be fitted with at least one recess, into which at least one conductor rail is introduced, which can be connected to a power source. Moreover, a cathode block, which has been processed like this before or after being provided, may be fitted with further means, e.g. it is possible to arrange a contact mass between the cathode block and the conductor rail.

In a preferred embodiment, the pre-compressed plate based on expanded graphite, which is implemented in the method according to the invention, is formed as a film. The implementation as a film is advantageous because the film may adapt easily to the shape of the gap or to the surface finish of a cathode block.

In a preferred embodiment, the method according to the invention comprises the following procedural step:

adapting the film to the dimensions of the at least one cathode block.

By adapting the film to the dimensions of the cathode block, the film can be arranged optimally on the cathode block, without creating edges, beads, or other types of unevenness, which are adjacent to or cover up areas of the cathode block, or without creating an irregular filling of a gap formed between the cathode blocks and resulting in cavities inside the cathode bottom. E.g., adapting the film is done by means of cutting the film to the dimensions of the cathode block.

In another preferred embodiment, the method according to the invention further comprises the following procedural step before or after the at least one cathode block is provided:

texturing at least one surface of the at least one cathode block.

Texturing may be done by roughening of the surface or grooving of the surface. Advantageously, at least one surface of a cathode block will be textured, which is opposite a surface of at least one further cathode block. Grooving can be done e.g., by means of cutting tools, while roughening is generated by means of an abrasive tool.

The cathode bottom according to the invention is used in an electrolytic cell for producing aluminum. In a preferred embodiment, the electrolytic cell comprises a tray generally including sheet iron or steel and having a circular or quadrangular, preferably rectangular, shape. The side walls of the tray may be lined with carbon, carbide, or silicon carbide. Preferably, at least the bottom of the tray is lined with thermal insulation. The cathode bottom is arranged at the bottom of the tray or on the thermal insulation. At least two, preferably 10 to 24, cathode blocks are arranged in parallel to each other with respect to the longitudinal dimension thereof with a predetermined clearance, so that a gap is formed therebetween, which is filled respectively by at least one pre-compressed plate based on expanded graphite. The intervals between the side walls and the filled gap and between the side walls and the cathode blocks are optionally filled with material including a pre-compressed plate based on expanded graphite, or with a conventional anthracite ramming mass. The cathode blocks are connected to the negative pole of a power source. At least one anode, such as for instance a Soderberg electrode, is suspended at a supporting frame connected to the positive pole of the power source and protrudes into the tray without touching the cathode bottom or the side walls of the tray. Preferably, the distance from the anode to the walls is greater than to the cathode bottom or the developing aluminum layer.

For the production of aluminum, a solution of aluminum oxide is subjected to igneous electrolysis in molten cryolite at a temperature of about 960° C., wherein the side walls of the tray will be covered by a solid crust of the molten mass, while aluminum will accumulate under the molten mass because it is heavier than the molten mass.

Further features and advantages of the invention will be explained with reference to the following figures, without being limited thereto.

In the figures:

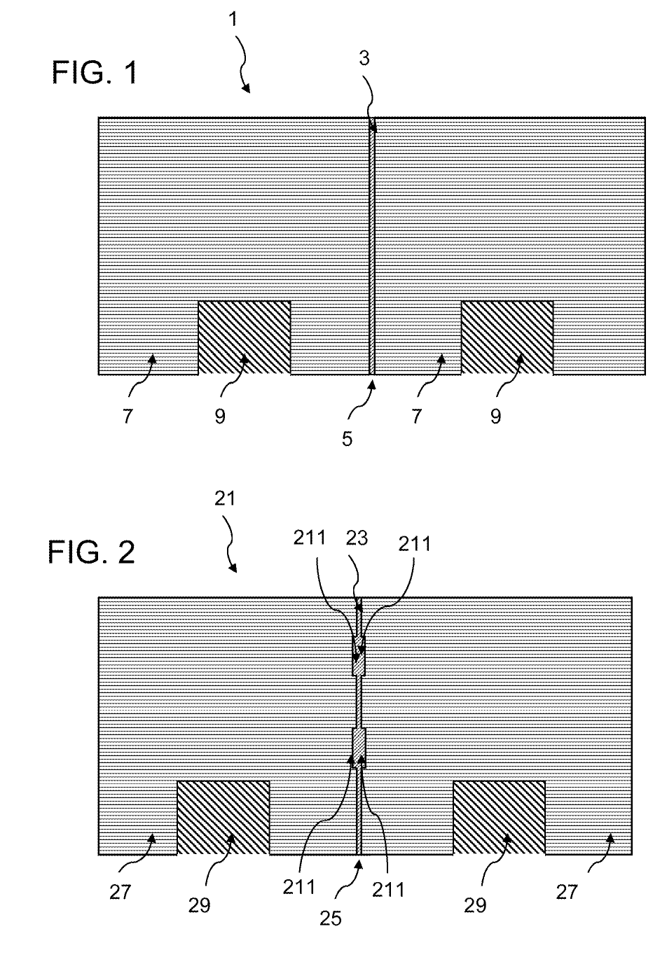

FIG. 1 shows a schematic cross-sectional view of a cathode bottom according to the invention;

FIG. 2 shows a schematic cross-sectional view of another cathode bottom according to the invention;

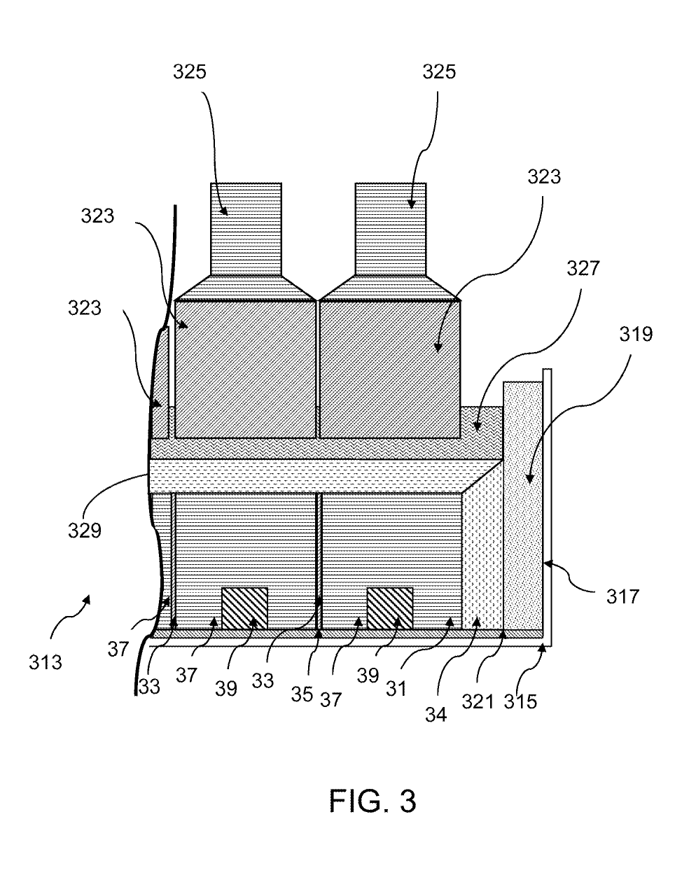

FIG. 3 shows a schematic cross-sectional view of one part of an electrolytic cell for producing aluminum, having a cathode bottom according to the invention;

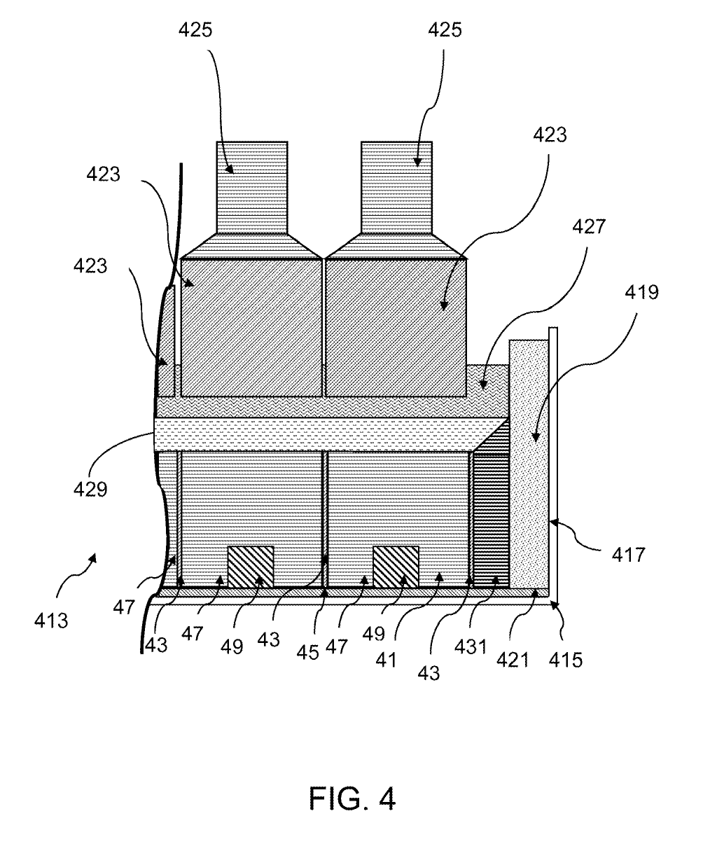

FIG. 4 shows a schematic cross-sectional view of one part of another electrolytic cell for producing aluminum, having a cathode bottom according to the invention;

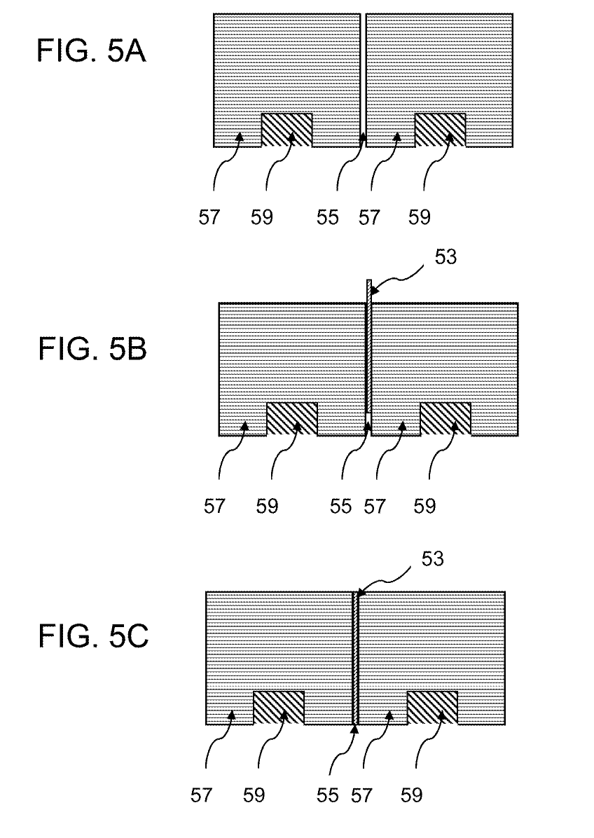

FIGS. 5a to 5c show a schematic illustration of a procedure for producing a cathode bottom according to the invention; and

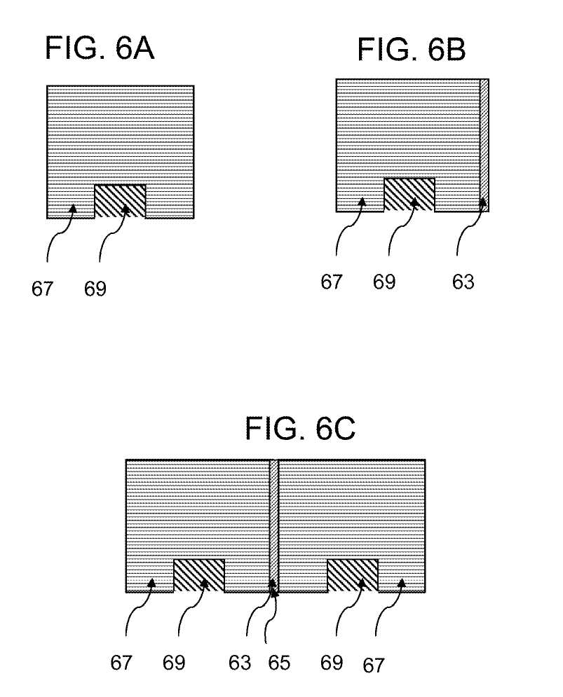

FIGS. 6a to 6c show a schematic illustration of another procedure for producing of a cathode bottom according to the invention.

FIG. 1 shows a schematic cross-sectional view of a cathode bottom 1 according to the invention. The cathode bottom 1 has a material 3 consisting of a pre-compressed graphite plate and filling the gap 5 formed between two cathode blocks 7. The cathode blocks 7 exhibit sufficient electrical and thermal conductivity for use in igneous electrolysis, and are made for instance of graphitized carbon. Each of the cathode blocks 7 has a recess 9 to receive a conductor rail (not shown), allowing the latter to be connected to a power source. The material 3 and the cathode blocks 7 are flush.

FIG. 2 shows a schematic cross-sectional view of another cathode bottom according to the invention 21. The cathode bottom has a material 23 consisting of a pre-compressed graphite plate filling a gap 25 formed between two cathode blocks 27. The material 23 and the cathode blocks 27 are flush. The cathode blocks 27 exhibit sufficient electrical and thermal conductivity for use in igneous electrolysis, and are made for instance of graphitized carbon. Each of the cathode blocks 27 has a recess 29 to receive a conductor rail (not shown), allowing the latter to be connected to a power source. Moreover, each of the cathode blocks 27 has two grooves 211. Each of the grooves 211 is arranged on a surface of a cathode block 27 located opposite a surface of the other cathode block 27. The material 23 will fill the gap 25 and the grooves 211. The grooves 211 will assist the non-positive connection between the material 23 and the cathode blocks 27 due to a positive connection with the material 23. In FIG. 2, each cathode block 27 has two grooves 211, however, the number of the grooves 211 made in one cathode block 27 is chosen arbitrarily and will depend on the dimensions of the cathode block 27.

FIG. 3 shows a schematic cross-sectional view of one part of an electrolytic cell 313 for producing aluminum. The electrolytic cell 313 has a tray 315 made of steel. The side walls 317 of the tray 315, one of which is shown in FIG. 3, are lined with blocks 319 of graphite, one of which is shown in FIG. 3. The bottom of the tray 315 is lined with a heat insulating layer 321, so that it is completely covered thereby. A cathode bottom 31 is arranged on the heat insulating layer 321. The cathode bottom 31 has a material 33 and cathode blocks 37, two of which are shown in FIG. 3, which are arranged at a predetermined distance, as well as a ramming mass 34. The material 33 comprises a pre-compressed graphite plate. The ramming mass 34 includes conventional ramming mass made of carbon. Between the cathode blocks 37, respectively one gap 35 is formed. The material 33 fills the gap 35, and the ramming mass 34 fills the respective interval between the cathode block 37 and the side wall 317 so that the heat insulating layer 321 is completely covered by the cathode bottom 31 including the ramming mass 34, the material 33, and the cathode blocks 37. As can be seen in FIG. 3, the material 33 is flush with the cathode blocks 37. Each of the cathode blocks 37 has a recess 39, which is adapted for receiving a conductor rail (not shown), which can be connected to a negative pole of a power source (not shown). Moreover, the electrolytic cell 313 has anodes 323, two of which are shown in FIG. 3, which are respectively suspended at a support 325 connected to a positive pole of a power source (not shown). Inside the electrolytic cell 313, there is a solution 327 consisting of aluminum oxide in molten cryolite. During electrolysis, aluminum 329 will collect between the solution 327 and the cathode bottom 31.

FIG. 4 shows a schematic cross-sectional view of one part of another electrolytic cell 413 for producing aluminum. The electrolytic cell 413 has a tray 415 made of steel. The side walls 417 of the tray 415, one of which is shown in FIG. 4, are lined with blocks 419 of graphite, one of which is shown in FIG. 4. At the blocks 419 of graphite, moreover, pre-fired blocks 431 of carbon or graphite are arranged, one of which is shown in FIG. 4. The bottom of the tray 415 is lined with a heat insulating layer 421, so that it is completely covered thereby. On the heat insulating layer 421, a cathode bottom 41 is arranged. The cathode bottom 41 has a material 43 and cathode blocks 47, two of which are shown in FIG. 4, which are arranged with a predetermined clearance. The material 43 comprises a pre-compressed graphite plate.

Between the cathode blocks 47, a gap 45 is formed, respectively. The material 43 will fill the gap 45, and moreover, another material 43 will fill an interval between a cathode block 47 and block 431 so that the heat insulating layer 421 is completely covered by the cathode bottom 41 including the material 43 and the cathode blocks 47. As shown in FIG. 4, the material 43 is flush with the cathode blocks 47. Each of the cathode blocks 47 has a recess 49 suitable for receiving a conductor rail (not shown), which can be connected to a negative pole of a power source (not shown). Moreover, the electrolytic cell 413 has anodes 423, two of which are shown in FIG. 4, which are suspended respectively at a support 425 connected to a positive pole of a power source (not shown). Inside the electrolytic cell 413, there is a solution 427 of aluminum oxide in molten cryolite. During electrolysis, aluminum 429 will collect between the solution 427 and the cathode bottom 41.

FIGS. 5a to 5c show a schematic illustration of a procedure for producing a cathode bottom according to the invention 51.

FIG. 5a shows how two cathode blocks 57 are provided, which are arranged at a predetermined clearance so that a gap 55 is formed. FIG. 5b shows that the material 53 including the pre-compressed graphite plate is inserted into the gap 55. FIG. 5c shows the cathode bottom 51, as it may be used for an electrolytic cell for producing aluminum. The material 53 will fill the gap 55. The quantity and dimensions of the material 53 are chosen so that the material 53 is flush with the cathode blocks 57 and fills the gap 55 completely. It should be noted that possible connections and connecting means of the cathode bottom 51 to a power source in FIGS. 5a to 5c have been omitted for the sake of clarity.

FIGS. 6a to 6c show a schematic illustration of another procedure for producing a cathode bottom according to the invention 61.

FIG. 6a shows how a cathode block 67 having a recess 69 for receiving a conductor rail (not shown) is provided. FIG. 6b shows that the material 63 including a pre-compressed graphite plate is two-dimensionally arranged on a surface of the cathode block 67, with an adhesive being used for fastening, if required. If required, a further material 63 can be arranged, so that a stack of material 63 is created (not shown), which is arranged on the cathode block 67. FIG. 6c shows that another cathode block 67 with a recess 69 is arranged on the material 63 so as to be non-positively connected with the cathode block 67 by means of the material 63. FIG. 6c shows the cathode bottom 61 as it may be used for an electrolytic cell for producing aluminum. By repeating the steps shown in FIGS. 6b and 6c, a cathode bottom with a plurality of consecutive cathode blocks can be created. It should be noted that possible connections and connecting means of the cathode bottom 61 to a power source have been omitted in FIGS. 6a to 6c for the sake of clarity.

1-13. (canceled)

14. A cathode bottom for an electrolytic cell for producing aluminum, the cathode bottom comprising:
at least one cathode block; and
a material configured to be disposed on said at least one cathode block, said material including a pre-compressed plate based on expanded graphite.

15. The cathode bottom according to claim 14, wherein said material configured to be disposed on said at least one cathode block is formed of a pre-compressed graphite plate based on expanded graphite.

16. The cathode bottom according to claim 14, wherein said pre-compressed plate is formed as a film.

17. The cathode bottom according to claim 14, which further comprises:
at least one further cathode block disposed at a predetermined distance from said at least one cathode block forming at least one gap therebetween;
said material filling said at least one gap.

18. The cathode bottom according to claim 17, wherein said at least one cathode block and said at least one further cathode block have surfaces, and one of said surfaces of said at least one cathode block opposite one of said surfaces of said at least one further cathode block has a textured surface.

19. The cathode bottom according to claim 17, wherein said at least one cathode block and said at least one further cathode block have surfaces, and one of said surfaces of said at least one cathode block opposite one of said surfaces of said at least one further cathode block has at least one groove.

20. The cathode bottom according to claim 17, wherein said at least one cathode block and said at least one further cathode block have surfaces adjacent said surfaces forming said at least one gap, and said material disposed on said surfaces forming said at least one gap and filling said at least one gap is flush with said adjacent surfaces.

21. A method for producing a cathode bottom, the method comprising the following steps:
providing at least one cathode block having surfaces; and
placing a material on at least one of the surfaces of the at least one cathode block, the material including at least one pre-compressed plate based on expanded graphite.

22. The method according to claim 21, which further comprises:
placing at least one further cathode block at a predetermined distance from the at least one cathode block forming a gap therebetween; and
filling the gap with the material.

23. The method according to claim 21, which further comprises carrying out the step of placing the material on at least one of the surfaces of the at least one cathode block by fastening the material with an adhesive.

24. The method according to claim 21, which further comprises forming the material as a film.

25. The method according to claim 21, which further comprises texturing at least one of the surfaces of the at least one cathode block before or after the step of providing the at least one cathode block.

26. An electrolytic cell for producing aluminum, the electrolytic cell comprising:
a cathode bottom according to claim 14.
